(19) United States
(12) Patent Application Publication
(10) Pub. No.: US 2026/0177527 A1
(43) Pub. Date: Jun. 25, 2026

(54) SYSTEM FOR DETECTING AND ANALYZING A SAMPLE CONTAINED IN A SAMPLE FLUID STREAM

(71) Applicant: Bruker Optics GmbH & CO. KG, Ettlingen (DE)

(72) Inventor: Uwe RENNER, Leipzig (DE)

(21) Appl. No.: 19/417,883

(22) Filed: Dec. 12, 2025

(30) Foreign Application Priority Data
Dec. 19, 2024 (DE) 102024139063.8

(51) Int. Cl. G01N 27/622

(52) U.S. Cl. CPC G01N 27/622

(57) ABSTRACT

Systems and methods detect and/or analyze a sample contained in a sample fluid stream. The systems and methods comprises a detection device the includes a sample chamber with a sample fluid inlet and a fluid outlet, into which the sample is introduced for analysis. The systems and methods comprise a mixing chamber and a sample supply stream, which has a sample supply stream inlet, an equalizing steam outlet, a dilution stream inlet, and a mixing chamber stream outlet, wherein the dilution stream inlet is connected to the fluid outlet in a fluid-conducting manner and the mixing chamber stream outlet is connected to the sample fluid inlet in a fluid-conducting manner to form a detection loop.

### TECHNICAL FIELD

The invention relates to a system for detecting and analyzing a sample contained in a sample fluid stream, which comprises a detection device, a mixing chamber, a first conveyor, a sample supply device and a second conveyor, to a sample receiving device for receiving and dosing a sample for the system according to the invention, and to a method for supplying and analyzing a sample contained in a sample fluid stream using a system according to the invention.

### BACKGROUND

Known inlet systems for fluid samples into a chemical detection device or into a spectrometer can be differentiated according to the type of supply into direct inlet and membrane inlet. In the case of a direct inlet, a direct convective flow or a partial flow of the sample occurs either from the environment or passively by diffusion via an opening into the sample chamber of the spectrometer, whereas in the case of a membrane inlet the sample instead enters the sample chamber indirectly by diffusion via a membrane, since the membrane obstructs the direct flow. Under normal operating conditions, pressure equalization exists between the sample chamber and the environment from which the sample is supplied. In the event of a change in the ambient pressure, for example due to rapid changes in altitude, this pressure equalization is established almost immediately with a direct inlet, whereas with a membrane inlet this can generally only occur slowly through permeation through the membrane.

In the case of a direct inlet, the sample generally enters the interior of the sample chamber of the detection device directly from the environment through a convective sample fluid stream, in some cases as a pure sample diffusion stream or as a superposition of both mechanisms. From there, a remaining part of the sample reaches convectively an outlet. Thus, sample enrichment in the detection device and, in the case of gases, their compression and an associated thermodynamic change of state in the detection device are prevented. The mass flows are mostly laminar due to the low flow velocities.

For a continuous sample supply, a mass flow or volume flow is provided. A excessively high mass flow or volume flow for the sample, which is, however, necessary to provide the sample from the environment of the detection device by suction at high pressure or high volume flow, can lead to overdosing and undesired accumulations, deposits, or contamination in the supply means and especially in the sample chamber.

In the case of the membrane inlet, the sample enters the sample chamber of the detection device indirectly via diffusion through a thin, fine-pored layer or membrane, wherein under normal operating conditions, pressure equalization exists between both sides of the membrane. During diffusion, the sample flow through the membrane occurs according to the Fick's first law. According to this law, the particle current density is proportional to the negative concentration gradient of the sample between the two sides of the membrane. The proportionality constant is the temperature-dependent diffusion coefficient, which depends on the membrane material and its structure, as well as on pore diameter, pore length, pore cross-linking or pore branching, and, sample-specifically, on the physical and chemical interaction of the sample molecules with the membrane material.

The membrane has a high flow resistance, as a result of which no significant convective sample flow occurs through said membrane at low pressure differences. The membrane inlet thus blocks a direct convective carrier stream from the environment into the sample chamber. Since pure diffusion is dominated by Brownian motion, no mean flow velocity through the membrane can be defined; instead, the propagation occurs according to the temporal development of the mean square displacement. Membrane inlet and direct inlet therefore differ fundamentally in their physical behavior. In the case of larger pressure differences, for example due to rapid changes in altitude, convective flows can additionally occur, which are referred to as permeation and are proportional to the pressure gradient. However, an excessive pressure difference mechanically stresses the thin membrane and can damage it. This is the reason why pressure equalization elements are used. In addition to pressure, the temperature range for the membrane materials is also limited, since deviations can cause irreversible damage. During sampling, the sample flows convectively past the membrane, wherein no flow velocity is present at the membrane surface due to the adhesion condition. The mass transfer with the membrane occurs in the transition layer purely through diffusion.

The concentration gradient and the sample flow through the membrane can be increased by thinner layers, wherein manufacturing-related and mechanical stability limits, e.g., during fastening, must be considered. A larger membrane area also increases the sample flow but is limited by space and fastening possibilities. The diffusion and the sample flow increase with rising temperature and are usually regulated by membrane heater. Upper limits of temperature due to material properties hinder the diffusion of molecules with higher molecular weight and lead to an accumulation at the membrane.

The sample diffused through the membrane is advantageously taken up from the membrane by a fluid stream, the membrane flow, and transported in the direction of the sample chamber. However, the sample can also diffuse in the direction of the sample chamber without a convective stream, albeit much more slowly.

A substance dependency of the diffusion through the membrane can be disadvantageous if, for example, larger sample molecules with high molecular weight are to be investigated and the pore structure of the membrane was designed for small molecules, since their movement is then severely hindered or they cannot diffuse through the membrane at all. As a result, their detection is greatly delayed or impossible. Moreover, molecules can accumulate in the membrane layer. Because of the limited temperature stability of the membrane, these can only be dissolved out of it with difficulty and time-consumingly, for example in a cleaning process, which limits the operational readiness of the spectrometer or the detection device.

WO 2017/055871 A1 describes a detector inlet for providing an aerosol for an analytical device, wherein the detector inlet comprises an inlet for receiving a stream of a gaseous fluid, wherein a part of the stream of the gaseous fluid is heated more strongly by a heating device than another part, which is subsequently mixed with the one part.

WO 2016/059407 A1 discloses an ion mobility spectrometer, IMS, with an inlet for sample gas and drift gas stream. The inlet has an opening, which can be controlled by a controller to open to obtain a gas stream entraining a sample through the inlet, and can also be controlled to restrict the flow through the sample inlet.

WO 2010/139861 A1 describes a device for the detection of aerosol nanoparticles. Here, a particle-free carrier stream is first saturated with a condensation medium, whereupon the saturated particle-free carrier stream is mixed with an aerosol gas stream. After mixing, the gas stream is directed to the detection device.

WO 2015/019059 A1 discloses an IMS spectrometer which is designed to heat an air sample taken into the spectrometer in order to vaporize aerosols entrained by this air sample before the sample is ionized for analysis. The air sample can be heated in the inlet of the spectrometer, in the reaction region in which the sample is ionized, or in a chamber of the spectrometer before the sample is directed into the reaction region.

DE 198 44 605 A1 describes a device for introducing gases containing solid particles into a sample chamber, wherein a nozzle for supplying the particle-gas mixture is arranged in front of the sample chamber. The nozzle opens into a chamber from which expanding gas of the particle-gas mixture can be suctioned off. The nozzle and the chamber are arranged in an insert that can be installed and removed as a unit.

WO 2022/024 011 A1 discloses a fluid measurement chamber with a circulation path between a first flow control element, a fluid storage chamber, and a second flow control element, wherein a sensor for determining the analyte concentration is arranged in the storage chamber. The measurement chamber comprises a fluid dilution unit, which introduces a reference fluid of defined concentration into the circulation path.

DE 697 32 693 T2 discloses a recirculating IMS/GC-IMS system, in which a carrier gas stream removed at the outlet is purified by filters, circulated by a pump, and discharged via a bypass at the level of the sample gas stream. The sample is fed into the return stream, optionally diluted with reference gas, and directed into the analyzer via a heated transfer line and an upstream gas chromatography column.

The invention is now based on the object of providing a device and a corresponding method which at least partially overcome the mentioned disadvantages of the prior art and enable an improved and controlled provision of a sample fluid stream containing the sample for analysis with the device.

### SUMMARY

This object is achieved by a system for detecting and analyzing a sample contained in a sample fluid stream as well as a corresponding method with the features of the independent claims. Advantageous embodiments of the invention are defined in the dependent claims.

According to the invention, a system for detecting and analyzing a sample contained in a sample fluid stream is provided. The system comprises a detection device for analyzing the sample, wherein the detection device includes a sample chamber with a sample fluid inlet for supplying the sample fluid stream and a fluid outlet, into which the sample is introduced for analysis. The system further comprises a mixing chamber for mixing a dilution stream and a sample supply stream, which has a sample supply stream inlet and an equalizing steam outlet, as well as a dilution stream inlet and a mixing chamber stream outlet, wherein the dilution stream inlet is connected to the fluid outlet in a fluid-conducting manner and the mixing chamber stream outlet is connected to the sample fluid inlet in a fluid-conducting manner to form a detection loop. Furthermore, the system has a first conveyor, which is designed to drive the detection loop for conveying the sample fluid stream, and a sample supply device comprising a sample inlet, which is connected to the sample supply stream inlet in a fluid-conducting manner by means of a first flow path for introducing the sample into the system, and a sample outlet, which is connected to the equalizing steam outlet in a fluid-conducting manner by means of a second flow path. The system further comprises a second conveyor for conveying a carrier stream containing the sample from the sample inlet to the sample outlet.

In other words, the first flow path comprises a first supply line in order to introduce the carrier stream via the sample inlet and to guide the sample supply stream to the sample supply stream inlet, and the second flow path comprises a second supply line in order to discharge the equalizing stream from the equalizing stream outlet and to guide the carrier stream to the sample outlet. Accordingly, the system comprises an input side having the sample inlet and the sample outlet, the mixing chamber, and an output side communicating with the detection device via the dilution stream inlet and the mixing chamber stream outlet, the latter being connected to the detection loop, which is maintained by the first conveyor. The carrier stream is generated by the second conveyor from the sample inlet to the sample outlet. With the convective sample supply by means of the sample supply stream into the mixing chamber, a convective equalizing stream flows out of it as a result of the law of conservation of total mass flow, without an additional conveying mechanism being required. Thus, a pressure equalization is simultaneously created between the sample supplied by means of the sample supply stream and an interior space of the sample chamber. Particularly in the case of gas spectrometers, compression or “pumping out” of the interior space of the sample chamber and an associated disadvantageous change in physical state, such as pressure, is avoided. During a dosing process in the analysis, the sample thus enters the detection device indirectly via the mixing chamber stream outlet, since it is previously mixed in the mixing chamber with a convective fluid stream from the dilution stream inlet. For illustrative purposes, the system can also be described as an equivalent to electrical engineering with the four basic inputs and outputs, two on the input side and two on the output side, as a flow four-pole, in the interior of which a transformation (mixing, conversion, change of state) of the convective inflows and outflows takes place by means of functional elements. The sample inlet and sample outlet form a sample-side flow four-pole input, which is connected to an environment and assumes an ambient pressure at the openings. The flow four-pole further has the mixing chamber with the dilution stream inlet and the mixing chamber stream outlet, the latter leading into the sample chamber of the detection device. The dilution stream inlet and mixing chamber stream outlet form the flow four-pole output. The convective fluid stream with defined analytical, for example, chemical properties in terms of purity, from the dilution stream inlet to the mixing chamber stream outlet is generated by means of the first conveyor, such as a pump. In this case, the mass flows of the dilution stream inlet and the mixing chamber stream outlet are equal in magnitude. Advantageously, the convective fluid stream via the dilution stream inlet into the mixing chamber is designed in such a way that, without sample dosing, no traces or signatures are detectable by means of the detection device. The characterization as a flow four-pole is analogous to a view known from system theory and is applied specifically in electronics. The pressure gradients at the input and at the output correspond equivalently to the voltages of an electronic four-pole. An essential element is the mixing chamber, in which the mixing or transformation (cf. transformer in electrical engineering) of the convective inlet and outlet fluid streams flowing into it takes place. Further, a feature is the convective feedback of the fluid streams through the convective equalizing stream from the equalizing stream outlet or the sample outlet. The sample is consequently drawn in convectively by means of the fluid carrier stream via the sample inlet. In this case, it also has, for example, the state of aggregation of the fluid carrier stream. In the operating mode “dosing”, the fluid is drawn in from the sample inlet by the second conveyor, e.g., a pump, preferably on the output side via the sample outlet. Alternatively, it can be pressed into the sample inlet using a conveyor.

The environment can refer to various areas. It can mean the actual environment, but also a connectable desorber or evaporator.

The convective flow four-pole is, in other words, a generalization of a membrane inlet, in which the flow four-pole input is separated from the flow four-pole output by a membrane with diffusive material exchange. In the generalization thus made, the membrane inlet can be understood as a diffusive flow four-pole, in which the sample flow from the sample inlet in the direction of the mixing chamber stream outlet takes place diffusively via the membrane into the mixing chamber. In the present convective flow four-pole, on the contrary, the sample enters the mixing chamber through a convective sample flow via the sample supply stream inlet. In the convective flow four-pole, the diffusive sample flow in the fluid stream is negligible compared to the convective sample flow, i.e., it is at least ten times smaller. The convective flow four-pole must ensure a mass flow from the mixing chamber to the sample outlet that is equal to the mass flow from the sample inlet into the mixing chamber. In general, this is achieved by the equality in magnitude of the mass flow of the dilution stream inlet and the mass flow of the mixing chamber stream outlet, which are connected to the detection loop, as a result of mass flow conservation.

The system thus brings together the advantage of the direct inlet over the membrane inlet, i.e., the ability to analyze even larger molecules almost without delay during sample dosing, with the advantage of the indirect sample supply of the membrane inlet, i.e., the ability to combine and dilute the sample portion flowing through the membrane in a dilution stream separated from the carrier stream of the sample by the loop of the detection device. Furthermore, the disadvantage of the direct inlet of a high carrier stream from the environment or sample supply stream that cannot be reduced at will, and the disadvantage of the membrane inlet of a passage of larger molecules that is hindered by diffusion and delayed in time, are avoided or reduced by the supply into the mixing chamber according to the invention. The sample chamber of the detection device is considered a closed system that is as free as possible from interfering contaminants that would interfere with the sample analysis. For this purpose, this closed system is purged via a circulation system. The sample enters the sample chamber with the aid of the same loop or a partial loop. Introduced sample portions remaining after the analysis are conveyed out by the circulation system. Due to the continuous operation enabled by this system, in contrast to discontinuous operation with pulse-like dosing, continuous measurements are possible over a longer duration to improve the detection performance. Due to the increased amount of data possible therewith, an increase in the signal-to-noise ratio, for example, in spectra, can be achieved by means of data accumulation or data modulation. The invention enables a continuous sample supply by means of fluid carrier media such as gases, but also liquids, over a longer period of time, in order to achieve, for example, a better signal-to-noise ratio during data acquisition through multiple accumulation or continuous modulation. In contrast to a direct inlet, the sample supply stream is not guided directly into the detection device, but only a portion thereof, which is mixed with a further fluid stream in the mixing chamber. The characteristic difference from a membrane inlet system is that the fluidics, which are separated on both sides at the membrane, are replaced by the mixing chamber with a convective exchange system, so that this can be replaced as an equivalent in systems with a membrane inlet.

In other words, the system comprises a modular sample inlet system for a detection device in which the sample is drawn in by a convective fluid flow. Using the components described, the arrangement is generally suitable for dosing fluid samples (gases, liquids) in a detection device with convective sample supply.

The mixing chamber is preferably designed as a separable, i.e., removable and insertable, module. Hereby, it can, for example, substitute the membrane inlet of an ion mobility spectrometer.

Detection devices for detecting fluid samples exist in various embodiments. They are available for both gaseous and liquid samples. Thus, it can be analyzed directly in the sample chamber by optical spectroscopy, i.e., by means of electromagnetic waves, on the basis of characteristic spectral lines in the corresponding frequency bands. On the other hand, the substances to be detected in a sample can, after interaction with a medium under the action of a force (pressure difference, electric field) in the relaxed, unaccelerated, i.e., drifting or migrating state, be differentiated and determined in terms of the transit time or drift time using a spectrometer or generally in the detection device. In the case of drifting in the field, such as a pressure gradient, during the interaction with the drift medium itself or a special, interacting boundary layer of the flow-guiding wall or both components, the sample can be charge-neutral (gas chromatography). The sample is often ionized for electronic detection, for example, with an ion mobility spectrometer, and then moves in an electric field and optionally by means of further fields such as a superimposed fluid flow. The drift medium can be gaseous, liquid, but also solid. Exemplary embodiments of such detectors for chemical substances are arrangements for electrophoresis and the electrochemical cell. The detection device can also be a mass spectrometer, into which the sample passes from the sample chamber via an orifice.

The conveyors are preferably pumps, such as diaphragm or rotary vane pumps and similar conveyors.

Preferably, the second conveyor is arranged downstream of the sample outlet or upstream of the sample inlet relative to the flow direction of the carrier stream and, in the former case, is connected to the sample outlet in a fluid-conducting manner and, in the latter case, is connected to the sample inlet in a fluid-conducting manner, in order to move the carrier stream from the sample inlet to the sample outlet.

The first and second flow path are each a general designation for a flow path traveled by the corresponding fluid stream. A flow path thus comprises flow-guiding or -conducting elements and can be a housing, a line, or a functional, fluid-conducting member between the sample inlet and the sample supply stream inlet or between the sample outlet and the equalizing stream outlet. The flow path can also be a combination of one or more of the elements mentioned and is then formed by their entirety. The first and/or the second flow path can comprise a pipe or multiple parallel pipes (in other words, channels, capillaries, or flow channels). The sample supply stream inlet can comprise an opening to the mixing chamber or, in a further embodiment, multiple such parallel openings. The equalizing stream outlet can comprise an opening from the mixing chamber or, in a further embodiment, multiple such parallel openings.

Insofar as fluid streams are described below, these fluid streams being characterized by their mass or volume flow, the mass flow is used for simplification. There is an essentially incompressible flow, so that ideally no density changes occur due to compression. This is the reason for why it is assumed that the density of different parts is constant on average and that the volume flow can be inferred directly from the mass flow with the aid of the density.

The carrier stream, the sample supply stream, the equalizing stream, the sample fluid stream, and the dilution stream are also generally summarized under the term fluid stream. The said fluid streams are, in particular, liquids, gases, or aerosols. In other words, the fluid is preferably a gas or a liquid or a mixture of gas and liquid, such as, an aerosol, in which small liquid droplets are present in gas. The sample contained in the fluid can be gaseous, liquid, or solid.

The carrier stream is defined by means of the same designation at the sample inlet and sample outlet. Within the system, its composition and/or its mass flow can change. In the case of a splitting of the carrier stream, its mass flow can change locally within the system. However, due to a continuous operating mode during sample analysis, the carrier stream at the sample inlet and at the sample outlet is essentially the same in terms of its mass flow (deviations less than 5%, preferably less than 2%, particularly preferably less than 1%). Although its composition can change, the designation carrier stream here serves as a functional description for streams entering and exiting the system or a fluid stream that serves to transport components, in the present case, in particular the sample. In the simplest case, the mass flow and the composition can correspond to the mass flow and the composition of the sample supply stream, but they can also differ from one another.

Unless explicitly stated, positional relationships always refer to a flow direction during a dosing operation, which relates to an operating mode in which a sample to be investigated is supplied to the detection device, i.e., in other words, relative to the flow direction of the carrier stream or the sample fluid stream.

According to one embodiment, the sample inlet and the sample supply stream inlet are identical and/or the sample outlet and the equalizing stream outlet are identical. According to this embodiment, the carrier stream and the sample supply stream are identical. The two streams then have essentially the same mass flow. In other words, the carrier stream containing the sample is introduced directly into the mixing chamber without further elements arranged in between, so that the carrier stream and the sample supply stream correspond to one another; and/or, the carrier stream, if applicable with remaining portions of the sample, is discharged directly from the mixing chamber. In this case, the mass flow of the carrier stream and the equalizing stream correspond to one another; however, due to the mixing, their composition will differ from one another during dosing with a sample. The first flow path is thus formed by the sample inlet and the sample supply stream inlet and/or the second flow path is formed by the sample outlet and the equalizing stream outlet.

According to an alternative embodiment, the sample inlet and the sample supply stream inlet are separate elements and/or the sample outlet and the equalizing stream outlet are separate elements. In other words, the carrier stream containing the sample is introduced indirectly into the mixing chamber with at least one further element arranged in between and/or the carrier stream, if applicable with remaining portions of the sample, is discharged indirectly the mixing chamber.

According to one embodiment, the first and/or the second flow path comprises a fluid-guiding line or a fluid-guiding channel. The line or the channel guide the corresponding fluid streams and transports them between components of the system. In this embodiment, the sample inlet leads, at least partially via a fluid-guiding line, in particular a pipe, a capillary, or as an extended cylindrical column, into the mixing chamber.

According to one embodiment, the sample supply stream inlet is connected to the first flow path in a fluid-conducting manner by means of a connecting line and/or the equalizing stream outlet is connected to the second flow path in a fluid-conducting manner by means of a connecting line.

According to one embodiment, the sample inlet is connected to the first flow path in a fluid-conducting manner by means of a connecting line and/or the sample outlet is connected to the second flow path in a fluid-conducting manner by means of a connecting line.

According to one embodiment, the mixing chamber is designed such that there is essentially pressure equality between the sample supply stream entering the mixing chamber through the sample supply stream inlet and the sample fluid stream exiting the mixing chamber through the mixing chamber stream outlet, wherein a pressure difference is at least less than 100 Pa, preferably less than 70 Pa, and particularly preferably less than 50 Pa. This applies analogously to the equalizing stream exiting the mixing chamber through the equalizing stream outlet and the dilution stream entering the mixing chamber through the dilution stream inlet. Hereby, it is possible in a preferred operating mode that essentially no pressure difference exists between the sample supply stream inlet into the mixing chamber and the mixing chamber stream outlet from the mixing chamber, being, however, at least less than 100 Pa. Equivalent to this is the pressure difference between the dilution stream inlet and the equalizing stream outlet.

The system according to the invention thus enables a time-continuous, convective supply of a fluid, generally inhomogeneous or multiphase, sample into a detection device, such as a spectrometer, into which the sample is indirectly taken up with a further convective stream and enters, combined in the mixing chamber, as a sample fluid stream. The sample fluid stream is part of an internal fluid loop of the detection device. The sample flow from the sample inlet to the detection device takes place convectively via the mixing chamber, in contrast to a membrane inlet, where the sample flow typically takes place by diffusion via a separating membrane, and in contrast to a direct inlet, where no mixing with a fluid stream takes place in a mixing chamber, but rather the sample is conveyed directly into the sample chamber via a separate conveying stream. The sample supplied outside the detection device, which contains a substance to be specified in a carrier fluid, enters the mixing chamber with the aid of a suction stream, the carrier stream. Particularly in the case of a gas spectrometer, such as the ion mobility spectrometer, it is advantageous if the drawn-in sample supply stream does not enter the sample chamber of the detection device directly, but rather after being mixed with a clean, dry dilution stream, whereby a higher detection sensitivity of the substance to be detected is achieved. In many cases, the suction stream carrying the sample is too large to be investigated directly with the detection device. However, a large suction stream is advantageous nor only for taking up the sample from the immediate vicinity of the sample inlet on the one hand, but also for being able to analyze said sample, as far as possible, without temporal transport delay on the other hand. In the case of detection devices with high detection sensitivity, such as an ion mobility spectrometer, an excessively high sample conveying flow, which is, however, necessary to provide the sample by suction at high pressure or high volume flow, can lead to undesired enrichments, deposits, or contamination in the supply lines and, in particular, in the sample chamber. Furthermore, it is particularly important that there is usually a direct dependency between the sample fluid stream and the intensity of the signal to be evaluated. The system fulfilling these objects comprises embodiments and operating modes for fluid sample supply in both the gaseous and the liquid state of aggregation. The functional elements of the fluidics used for this purpose are suitable, in particular for ion mobility spectrometers, but also generally for spectrometers or detection devices, for detecting fluid samples.

In a preferred embodiment of the invention, it is provided that the system further comprises a control unit, which is connected to the first conveyor and/or to the second conveyor and is set up to control or regulate a first conveying capacity of the first conveyor, and/or a second conveying capacity of the second conveyor. In general, the convective inflows and outflows in the system, in other words at the flow four-pole, and in the interior are assumed to be stationary or only slowly changing mass flows, which are preferably in or regulated to flow equilibrium. By changing the first conveying capacity, a volume or mass flow of the sample fluid stream is thus changed; or by changing the second conveying capacity, a volume or mass flow of the carrier stream and/or the sample supply stream is changed. This is possible independently of one another. A regulation preferably takes place as a function of an operating variable of the sample fluid stream, the carrier stream, and/or the sample supply stream. In other words, the system comprises a control unit which is set up to ascertain an output for controlling or regulating the first conveying capacity of the first conveyor and/or the second conveying capacity of the second conveyor and to output it to the first and/or second conveyor. The output can comprise a control command or the like, which causes the conveyor to adjust or set its conveying capacity. The streams on the input side and the output side are thus generated by separate fluid conveying mechanisms and are advantageously regulated to a fixed value in a controlled manner. Hereby, an improved, controlled dosing of the sample into the detection device is achievable, for example, by regulating the carrier stream.

In a preferred embodiment of the invention, it is provided that the connection between the control unit and one of the controlled or regulated components is designed differently depending on the system and serves for regulation, monitoring, and/or communication. Preferably, the control unit takes over central control and regulation tasks by sending signals to the corresponding component in order to adjust or control its operation. These include commands such as start, stop, or changes to specific operating parameters. Alternatively, one or more of the present components are also equipped with a separate, independent control unit, which is directly matched to specific requirements. Preferably, the corresponding component reports data, such as operating states or environmental parameters, back to the control unit via sensors or other acquisition systems. This information enables precise monitoring and dynamic adjustment of the control system. In more complex systems, such as in a closed control loop, a continuous comparison takes place between the current operating data and the target specifications, whereby optimal function is ensured. The communication between the control unit and the corresponding component thus preferably takes place in both directions.

According to one embodiment, the operating variable is a predetermined volume or mass flow. The predetermined volume or mass flow is preferably based on a predetermined ratio of the volume or mass flow of the sample fluid stream and the volume or mass flow of the sample supply stream. Alternatively, the predetermined volume or mass flow is based on a predetermined ratio of the volume or mass flow of the dilution stream and the volume or mass flow of the sample supply stream.

According to one embodiment, the operating variable is a predetermined temperature of the carrier stream, the sample supply stream, and/or a surface temperature of flow-guiding elements of the sample supply device. In other words, a regulation is then carried out as a function of a temperature value, preferably ascertained by a temperature sensor. Hereby, mechanisms such as targeted condensation, enrichment, or an influencing of a flow resistance can be achieved. These effects depend on the temperature, so that, at a determined temperature, the mechanisms can be strengthened or weakened by changing the conveying capacity. The value to be regulated can thus be set by the temperature depending on the task. Thus, in the case of a low temperature, the carrier stream can be reduced for the purpose of targeted condensation or sample enrichment.

According to one embodiment, the control unit is further set up to ascertain and set a manipulated variable, preferably a rotational speed, of the first and/or the second conveyor for controlling or regulating the conveying capacity.

According to one embodiment, the control unit is set up to ascertain a current volume or mass flow of the corresponding fluid streams, preferably as a function of a current pressure value ascertained by a pressure sensor connected to the control unit or as a function of a current flow rate value ascertained by a flow controller connected to the control unit. The first and the second flow path, or parts thereof, have a fixed flow resistance, which can be used to measure the flow rate value. The fluid stream via the sample supply stream inlet or equalizing stream outlet can be measured directly by a corresponding flow sensor (flow controller). With the aid of a previously determined flow resistance R of the first and the second flow path or a part thereof, these fluid streams can be measured indirectly by means of differential pressure measurement, for example, between the mixing chamber and the sample inlet by a differential pressure sensor or between the mixing chamber and the sample outlet by a differential pressure sensor. Through the measured mass flows, which are equal in magnitude due to mass flow conservation, the desired mass flow can be set by means of the control unit using the manipulated variables of the second conveyor, such as, the rotational speed of the motor of a pump, and it can be determined which quantity of the sample enters the mixing chamber. Preferably, the volume flow Φ of the sample supply stream into the mixing chamber is determined indirectly via the flow resistance R of the first flow path or a part R thereof by measuring the differential pressure Δp between two points of the first flow path via Φ=s*Δp with s=1/R, wherein one point can be located in the mixing chamber. Since the equalizing stream is equal in magnitude, the differential pressure measurement can also take place via the flow resistance of the second flow path, if the flow resistance of the second flow path is not much smaller than the flow resistance of the first flow path. This measured differential pressure can be evaluated with the control unit and the desired sample supply stream or, equivalently, the equalizing stream can be regulated to a desired value.

According to one embodiment, the system further comprises a pressure sensor for acquiring and ascertaining the pressure value, which is preferably a differential pressure, of a fluid stream of the occurring fluid streams (sample fluid stream, dilution stream, carrier stream, sample supply stream, equalizing stream). The system can comprise a plurality of pressure sensors, each of which is designed to measure the pressure value of one of the fluid streams.

According to one embodiment, the system further comprises a flow controller for acquiring and ascertaining the current volume or mass flow of a fluid stream of the potentially occurring fluid streams (sample fluid stream, dilution stream, carrier stream, sample supply stream, equalizing stream). The system can comprise a plurality of flow controllers, each of which is designed to measure the current volume or mass flow of one of the fluid streams. The flow controller is preferably designed to regulate and measure the flow rate, so that this function is transferred from the control unit to the flow controller or the flow controller is the control unit. The actual flow rate is measured through a built-in sensor, and is regulated actively by the system in order to achieve and maintain a predetermined target value. The mutually independent fluid streams on the sample supply device side and on the detection device side are thus maintained by conveyors for fluids, such as pumps, and are preferably regulated by flow sensors or flow controllers.

According to one embodiment, the system further comprises a temperature sensor for acquiring and ascertaining the temperature of a fluid stream of the potentially occurring fluid streams (sample fluid stream, dilution stream, carrier stream, sample supply stream, equalizing stream) and/or a surface temperature of flow-guiding elements of the sample supply device. The system can comprise a plurality of temperature sensors, each of which is designed to measure the temperature of one of the fluid streams.

In a preferred embodiment of the invention, the system comprises a flow-splitting device, which is designed to split the carrier stream into a first partial carrier stream along the first flow path to the sample supply stream inlet and a second partial carrier stream along a third flow path, which is connected to the first and the second flow path in a fluid-conducting manner, to the sample outlet. In other words, the system further comprises a third flow path for splitting the carrier stream into at least two partial carrier streams, wherein the third flow path is connected to the first flow path by means of a first branch in a fluid-conducting manner and is connected to the second flow path by means of a second branch in a fluid-conducting manner. Hereby, the first partial carrier stream can flow along the first flow path in the direction of the sample supply stream inlet and flow into it, whereas the second partial carrier stream can flow along the third flow path in the direction of the second flow path and flow into it. In other words, the first partial carrier stream then corresponds to the sample supply stream. The first partial carrier stream and the second partial carrier stream then recombine before the sample outlet, preferably in the second flow path. Accordingly, the flow-splitting device has a starting point, at which the splitting begins, and an end, where the splitting ends again through recombination. In other words, the system further comprises a flow-splitting device, which is designed to guide a second partial carrier stream of the carrier stream past the mixing chamber to the sample outlet. The system thus combines a convective partial stream of the carrier stream, namely the sample supply stream, which is defined by flow split and is in particular continuous during the data acquisition of the detection device, in the mixing chamber with a separate fluid stream, namely the dilution stream. By means of the flow split, an overdosing of the sample can be reduced by appropriate dimensioning of a splitting ratio. The flow-splitting device is particularly advantageous if the sample flow can lead to an overdosing due to the suction of the carrier stream. If the sample inflow with the carrier stream via the sample inlet is low, then in a simplified embodiment, no flow-splitting device is required, so that the carrier stream can enter the mixing chamber directly as the sample supply stream. For this purpose, either the flow-splitting device can be omitted or it is preferably designed to be activatable and deactivatable, for example, by greatly increasing the splitting flow resistance or completely blocking the third flow path. In this embodiment, a suitable second conveyor, such as a pump, is required for low mass or volume flows, which is preferably regulated by the control unit in order to achieve a defined dosing.

According to a further preferred embodiment of the invention, the sample supply device comprises at least one supplementary flow resistor. In principle, all fluid-technical elements comprise a flow resistance, referred to in the present case also as inherently present flow resistance R, which is already suitable for adjusting a fluid stream. For simplification and illustration, the intersection point between a characteristic curve of the flow resistance, which describes the functional dependency Φ=g(Δp) of the volume flow Φ on the pressure difference Δp, such as, the linear dependency Φ=1/R*Δp mentioned previously, analogous to Ohm's law, and a characteristic curve Φ=1/R*Δp of the conveyor (for example, a pump characteristic curve), given by Φ=f(Δp), is used here. In the simplest case, the conveying characteristic curve f is likewise a linear relationship between two points, given by the maximum volume flow Φₘₐₓ at Δp=0 and by the maximum pressure difference Δpₘₐₓ at vanishing volume flow Φ=0. The intersection point of both characteristic curves represents the operating point at which the conveyor operates. Consequently, the inherently present flow resistance influences the operating point. However, it does not enable a desired or predetermined setting. This is then defined only by pump regulation and not by external specifications. Additionally, a total flow resistor of the sample supply device can thus comprise the supplementary flow resistor, referred to in the present case also as a predefined flow resistor, which differs from the inherently present flow resistor in that its primary purpose is to modify the total flow resistor, and which is predetermined by the design of the elements, for example, their shape and surface, unlike the other elements contributing to the total flow resistor, such as lines, filters, etc., whose primary purpose is initially to be seen in the transmission and guiding of the fluid. In other words, the system has the inherent flow resistor due to its transport function of the streams, whereas the supplementary flow resistor is added supplementarily, so that together they form the total flow resistor. Preferably, the supplementary flow resistor is designed to adjust the volume or mass flow of the carrier stream and/or the sample supply stream.

In a preferred embodiment, the supplementary flow resistor, in particular its flow-guiding walls, can be tempered to a predetermined operating temperature by means of a heating device. As is known, the flow resistance depends not only on the geometry, but also on the temperature-dependent density and viscosity of the fluid. Higher temperatures additionally promote the mixing of the substances contained in the sample carrier stream due to the increased diffusion. The heating device is preferably a heating spiral, heating coil, or inductive heating.

According to one embodiment, the first flow path comprises a supplementary first flow resistor and/or the second flow path comprises a supplementary second flow resistor. In particular, flow conditions between the sample inlet and the sample supply stream inlet, as well as the mixing chamber stream outlet and the sample outlet, and the operating point of the conveyor can thus be adjusted by the respective flow resistors. According to one embodiment, the third flow path comprises a supplementary splitting flow resistor. The sample is preferably conveyed by the optional flow-splitting device, either completely (the splitting flow resistor is then infinitely large in the mathematical sense, and in the practical sense preferably at least 100 times larger, in particular, however, 200 times larger than the sum of the first and second flow resistor), or proportionally convectively via the sample supply stream inlet of the mixing chamber and via the mixing chamber stream outlet to the detection device as well as in the direction of the sample outlet. In this case, the first partial carrier stream (i.e., the sample supply stream) that has entered the mixing chamber is mixed with the fluid stream from the dilution stream inlet and is conveyed convectively as a combined stream or sample fluid stream to the mixing chamber stream outlet. In other words, a combination of the flow-splitting device and the first and second flow resistor as well as the splitting flow resistor is particularly advantageous. Hereby, the sample flow from the sample inlet is split into the first partial carrier stream and the second partial carrier stream by means of the first flow resistor and the splitting flow resistor. Alternatively, the flow split can also take place on the output side by means of the splitting flow resistor and the second flow resistor. Likewise, the flow split is possible with all supplementary flow resistors. The dimensioning of the flow splitter via these flow resistors depends on the desired proportional sample flow into the mixing chamber. With a fixed choice of the flow resistors, the inflow from the second conveyor can be varied within certain limits.

According to one embodiment, the supplementary flow resistor comprises an orifice with a defined flow resistance.

In a further embodiment, the first flow resistor is fixedly dimensioned and is a pipe that can be pluggably inserted into the mixing chamber, a cylindrical column that can be pluggably inserted into the mixing chamber, or a capillary that can be pluggably inserted into the mixing chamber. The fixedly dimensioned first flow resistor can also be a flow orifice with a defined inner hole diameter. This flow orifice can be regarded as a limiting case of the aforementioned pipe with a length that is small or negligible compared to the diameter. Due to the pluggability of the first flow resistor into the mixing chamber, an adaptation to the flow conditions can be achieved. To ensure comparable flow conditions, calibrated flow resistors are preferably used. The pluggability and thus interchangeability also facilitates cleaning. In other words, preferably multiple of these fixed, not necessarily identical, parallel-arranged flow resistors can lead from the sample inlet via openings into the mixing chamber with the total first flow resistor. Analogous features apply to the output side and the second flow resistor. In particular, these separate flow resistors can be combined and embedded as capillaries in bundles or stalks in a cylindrical shell and partially or completely fill this shell. A parallel design can be advantageous if the optimal choice of the flow resistors is not known, since the flow conditions can change depending on the application case, but a fixed selection of calibrated flow resistors connected to the mixing chamber is available without having to replace an entire inlet system. Preferably, a selection that is staggered or coded on the basis of a basic flow resistor, for example, according to the binary number system, is made, which reduces the number of necessary combinations. Depending on the application purpose, these flow resistors can be activated or deactivated by mechanically closing or opening the parallel openings completely using closures such as cylinders or cones.

According to one embodiment, a first section of the first flow path, which leads into the mixing chamber and carries the first partial carrier stream, is a pipe, a capillary, or a nozzle. In addition, the first section can also be designed spirally wound, wherein, as is known, the inner diameter and channel length as well as dynamic viscosity determine the associated flow resistance, which can be determined from the Navier-Stokes equations. In the case of laminar pipe flows with pipe lengths that are large compared to the pipe radius, the flow resistance increases according to the Hagen-Poiseuille law reciprocally with the fourth power of the pipe radius and can be directly calculated herewith. The third flow path in the direction of the sample outlet likewise has an associated flow resistance. The flow resistances can be determined by means of the finite element method through simulation. In general, the simulation makes an application-oriented dimensioning of the flow-splitting device possible, which can be adapted to the flow conditions during the suction of the sample.

According to one embodiment, the sample supply stream inlet and/or the equalizing stream outlet form at least a part of the supplementary flow resistor, preferably of the first and/or the second flow resistor.

According to one embodiment, the first flow resistor is arranged after the flow-splitting device. In other words, the first flow resistor is arranged downstream of the flow-splitting device and upstream of the sample supply stream inlet relative to a flow direction of the carrier stream, or between the first branch and the sample supply stream inlet, i.e., after the flow split. Accordingly, the first section comprises the first flow resistor.

According to one embodiment, the second flow resistor is arranged upstream of one end of the flow-splitting device. In other words, the second flow resistor is arranged upstream of a fluid-conducting connection between the second flow path and the third flow path and downstream of the equalizing stream outlet relative to a flow direction of the carrier stream, or between the equalizing stream outlet and the second branch, i.e., before the recombination of the first and second partial carrier stream. In other words, the second flow path comprises a second section, which carries the equalizing stream, wherein the second section comprises the second flow resistor.

According to one embodiment of the invention, the supplementary flow resistor is adjustable in steps or continuously. Preferably, the first and/or the second flow resistor are adjustable in steps or continuously, and/or the splitting flow resistor is adjustable in steps or continuously. Since the flow resistance is, inter alia, dependent on flow conditions, either observations under the same conditions can be made for comparison and classification of the flow resistors in order to determine the flow resistance as described above, or reference is made exclusively to the pipe friction factor (for example, in the case of lines) or the drag coefficient (for example, in the case of bodies with flow around them) with regard to the flow resistance. The pipe friction factor (also pipe friction coefficient) 2 is a dimensionless characteristic number for calculating the pressure drop of a flow due to the flow resistance in a pipe. The dimensionless drag coefficient describes how strongly the component inhibits the flow, based on its geometry. It is useful for comparing flow resistances of different components and is often used in fluid mechanics. The ratio of multiple flow resistances influences the flow split. If, for example, the splitting flow resistor is much smaller compared to the first flow resistor, but at least 10 times smaller, the flow split is essentially determined by the ratio of the first flow resistor to the splitting flow resistor. With the change of the flow resistance, the dosing quantity of the sample and thus the signal intensity of the spectrum to be evaluated can be adapted.

According to one embodiment, the supplementary flow resistor is manually or automatically adjustable.

According to one embodiment, the supplementary flow resistor is adjustable by an actuating mechanism. The actuating mechanism is preferably a device for changing a flow cross-section or also a flow-through cross-section, for activating and deactivating flow obstacles, for aligning flow obstacles, for changing the temperature of flow-guiding parts of the supplementary flow resistor, or is an exchange mechanism for using various resistors that are detachably inserted, in particular into one of the corresponding flow paths. In other words, the system further comprises at least one actuating mechanism (actuating element or actuator) connected to the supplementary flow resistor for changing the supplementary flow resistance.

According to one embodiment, the actuating mechanism comprises a throttle, a slide, a valve, or the like.

According to one embodiment, the supplementary flow resistor comprises a plurality of parallel calibrated flow resistors, which can be selectively activated and deactivated by means of the actuating mechanism.

According to one embodiment, the supplementary flow resistor is configured to be variable—similar to a valve. The first and/or second flow resistor are preferably cylindrical or conical guides, into which, in one embodiment, movable parts can be inserted as cylindrical pins, needles, or cones in a non-sealing manner with a remaining fluid gap; their cross-section and preferably the immersed length or the penetration depth makes the flow resistance variable. The corresponding fluid gap, through which the fluid stream can flow in an adjustable manner, is connected to the sample supply stream inlet or the equalizing stream outlet of the mixing chamber. The mechanical adjustability is preferably achieved by means of adjusting screws, which can advantageously be located accessibly in threads outside in a wall enclosing the sample supply device. The movable parts of such variable flow resistors are preferably also helical geometries such as spirals, but also filters such as a particle filter with defined permeation. A series connection of fixed and variable flow resistors is preferred, for example, as a staggered arrangement of movable cylinders or cones, which become effective depending on the penetration depth in the above-mentioned guide. In addition, there is a possibility that a part of the supplementary flow resistor, for example, a partial section of the flow channel leading into the mixing chamber, is fixed, and an adjoining part is variable.

Preferably, the supplementary flow resistor is automatically adjustable by the control unit connected to the actuating mechanism. Preferably, the control unit is set up to control the supplementary flow resistor, or to regulate it preferably as a function of an operating variable of the sample fluid stream, the carrier stream, and/or the sample supply stream. In other words, the control unit is set up to control a manipulated variable of the supplementary flow resistor, or to regulate it preferably as a function of at least one operating variable of the carrier stream and/or the sample supply stream. In this case, the manipulated variable is in particular a flow cross-section or also a flow-through cross-section, an activation and deactivation of flow obstacles, an alignment of flow obstacles, a change in the temperature of flow-guiding parts of the supplementary flow resistor, or an exchange mechanism for using various resistors that are detachably inserted, in particular into one of the corresponding flow paths. In other words, the control unit is set up to adjust the manipulated variable by means of the actuating mechanism.

According to one embodiment, the operating variable is a predetermined volume or mass flow. The predetermined volume or mass flow is preferably based on a predetermined ratio of the volume or mass flow of the sample fluid stream and the volume or mass flow of the sample supply stream. Alternatively, the predetermined volume or mass flow is based on a predetermined ratio of the volume or mass flow of the dilution stream and the volume or mass flow of the sample supply stream.

According to one embodiment, the operating variable is a predetermined temperature of the carrier stream, the sample supply stream, and/or a surface temperature of flow-guiding elements. In other words, a regulation is then carried out as a function of a temperature value, preferably ascertained by a temperature sensor.

According to one embodiment, the system further comprises a drive unit for actuating the actuating mechanism (the actuating element or the actuator), which is connected to the control unit. In other words, the control unit is set up to ascertain an output for controlling or regulating the supplementary flow resistor as a function of an operating variable of the carrier stream and/or the sample supply stream and to output it to the drive unit.

Particularly preferably, the previously described adjustability of the movable part of the supplementary flow resistor is changed and monitored by in particular electro-mechanical actuators through positioning by means of the control unit. The actuator is connected to the movable part of the flow resistor, for example, to the previously mentioned pins, needles, or cones. Levers can be used as actuators, which can be moved by means of electromechanical relays (see dot matrix printer) or by thermal deformation using bimetals. Bimetal levers can regulate the sample supply as a function of a target temperature of the flow resistors leading into the mixing chamber and, in particular, block the supply if the temperature is too low. Using the actuators, both a stepwise and a continuous adjustment of the flow resistance are possible, and changes that are pre-settable and also adapted to the sample dosing or to the analyzed spectrum can be undertaken through a program monitored by the control unit. In conjunction with the sample evaluation, the sample inflow into the mixing chamber can be undertaken in a controlled manner by changing the supplementary flow resistor or can be blocked with a cone as a plug, and thus the mixing portion into the detection device can be undertaken in a controlled manner or can be blocked with a cone as a plug, so that an overdosing or contamination (splash protection) can be avoided. A special case is the complete closure of the sample supply stream inlet and the equalizing stream outlet. The controlled, variable adjustment of the supplementary flow resistor is an advantage over a membrane inlet system, because the passage through a permanently installed membrane cannot be easily changed or would require for example a complex partial covering of the membrane surface, for example, by means of an (adjustable) orifice.

In the case of the previously mentioned parallel or staggered, fixed flow resistors, the control unit is preferably designed to digitally control a programmable, in particular coded, selection of the mutually independent supply lines to be opened and closed to the mixing chamber by means of actuators, so that an adaptation of the dosing to the total sample flow can take place.

According to one embodiment, the sample supply device comprises a differential pressure sensor, which senses the pressure difference between the mixing chamber and the environment of the system, wherein the control unit is set up to throttle or completely block the sample supply stream to the mixing chamber by means of an actuator as a function of pressure changes, for example, as a result of changes in altitude of the detection device. Such a blocking is also advantageous if the detection device detects an overdose, for example predicted by means of time series analysis, by evaluating a detector signal by means of the control unit or other auxiliary sensors.

According to a further preferred embodiment, the sample supply device comprises a motor, which is designed to move the movable part of the supplementary flow resistor into or out of the channel step-by-step via a gear mechanism. In a miniaturized design, the mechanical change of the flow resistors can be realized by micro-electromechanical system elements (MEMS elements).

According to one embodiment, the control unit is further set up to ascertain a physical state of the supplementary flow resistor, which is preferably acquired by means of sensors, and to analyze the sample in addition to measured values at the detector or spectra based on the physical state, for example, by statistical methods or by pattern recognition. The sensors preferably comprise a temperature and pressure sensor and optionally a humidity sensor.

In a preferred embodiment of the invention, it is provided that the system further comprises an enrichment device for enriching the sample in the sample fluid stream, carrier stream, and/or sample supply stream.

In a further preferred embodiment of the invention, it is provided that the system further comprises a homogenization device for mixing the sample in the sample fluid stream, carrier stream, and/or sample supply stream and/or for reducing condensation of the sample in the carrier stream, in the sample supply stream, and/or in the sample fluid stream. In other words, the homogenization device is designed to prevent or at least reduce condensation or phase separation in the fluid and to enhance mixing.

According to a preferred embodiment of the invention, the control unit is further set up to activate and deactivate a function of the enrichment device and/or the homogenization device.

Preferably, the control unit is set up to control an enrichment performance of the enrichment device and/or a homogenization performance of the homogenization device, or to regulate the enrichment performance and/or the homogenization performance as a function of an operating variable of the sample fluid stream, the carrier stream, and/or the sample supply stream. The enrichment performance relates to the ability of the system to selectively concentrate (enrich) specific substances from a mixture or environment, in the present case the sample. The enrichment performance is a measure of how well a method or material is able to bring a substance (often present in low concentrations) to a higher concentration. The enrichment performance can be quantified by an enrichment factor, which is determined by the ratio of the concentration of the substance after enrichment to the concentration of the substance before enrichment. The homogenization performance describes the ability of the system to produce a uniform distribution of components, in the present case the sample, within a mixture. The goal is to minimize or completely eliminate differences in composition, consistency, or structure within a material. The homogenization performance is a measure of the efficiency with which a process or a device can convert heterogeneous components into a homogeneous mixture. The homogenization performance in the context of preventing condensation and the uniform distribution of the sample in the fluid stream describes the ability of the system to keep the fluid phase stable and uniformly distributed. This is crucial to ensure an accurate analysis and a consistent sampling. In the case of gas samples with volatile components, condensation can occur if the gas cools down or pressure fluctuations occur. Condensation leads to a non-uniform distribution of the components in the fluid stream and can falsify the analysis. Without sufficient homogenization, components of the sample may not be uniformly distributed in the fluid stream, which leads to measurement errors or unrepresentative results. The homogenization performance ensures that all components of the fluid are uniformly distributed in the fluid stream in order to enable precise sampling or analysis. The homogenization performance can be evaluated on the basis of various parameters or a combination of these parameters. A central factor is the degree of homogeneity, which describes the uniformity of the distribution and is ascertained mathematically via the standard deviation of the concentrations relative to the average concentration by H=1−x/σ, with the standard deviation of the concentrations at different points in the fluid stream σ as well as the average concentration x. A nearly perfect homogenization is expressed by values close to 1. Preferably, the value should be greater than 0.7 and particularly preferably greater than 0.9. For the prevention of condensation, the temperature stability ΔT plays a crucial role. Fluctuations in temperature should be minimal, preferably below 1° C. over the length of a considered section of the sample supply device which contains the homogenization device, in order to keep the fluid phase stable. Equally important is the pressure stability Δp, since pressure fluctuations can promote condensation. These should not exceed 1% of the system pressure. A further criterion is the flow velocity, which is optimally in the range of laminar flow (Reynolds number <2300) to avoid turbulence and dead zones that could promote a non-uniform distribution. In application, these parameters can be modeled by simulations, such as, computational fluid dynamics (CFD), and validated experimentally with sensors along the system. These evaluations help to optimize the system. The combination of these parameters enables a precise assessment and adjustment of the homogenization performance, which is essential for accurate analyses and stable sampling conditions.

According to one embodiment, the homogenization device comprises a heating device for tempering at least one of the sample fluid stream, the carrier stream, and/or the sample supply stream; and/or the homogenization device comprises a mixer. The system hereby preferably ensures that the temperature of the fluid remains constant, so that liquid components remain in the fluid phase. Heated lines or components keep the temperature in the case of gases above the condensation point to prevent condensation. The use of a heating device makes it possible to create stable conditions. Mixing and distribution are preferably achieved by swirlers or diffusers. These promote the uniform distribution of the fluid components in the fluid stream. The mixer is preferably a laminar mixer such as a static mixer or a helical mixer, which combine mechanical and fluid-dynamic processes to produce a homogeneous mixture. Particularly advantageous is a combination of a heating device, which can be designed both as a resistance heater and as an inductive heater, and a mixer, by which the diffusive mixing in the mixer is promoted with a heating device. The heating device is preferably a heating spiral, heating coil, or inductive heating.

Preferably, the mixer itself comprises the heating device. Accordingly, it can be formed by the shaping heating elements, so that it combines both functionalities in itself.

According to one embodiment, the enrichment device comprises a cooling device for tempering the sample fluid stream, the carrier stream, and/or the sample supply stream.

Preferably, the enrichment device comprises elements, through which at least one of the sample fluid stream, the carrier stream, and/or the sample supply stream flows, which enlarge a surface over which the fluid flows. Such an enlargement of the surface area can take place, for example, by splitting the first flow path by means of multiple parallel connections, channels, or capillaries. However, it can also be realized by means of porous bodies of known permeability.

According to one embodiment, the sample supply device and/or the mixing chamber comprises the homogenization device and/or the enrichment device. Preferably, the sample supply device and/or the mixing chamber comprises the heating device and/or the cooling device. The mixing chamber itself can be heated by thus heating device or be additionally heated, in order to avoid deposits and condensation. The sample inlet can be heated with the heating device to prevent or eliminate deposits or condensation on the surface. For this purpose, it preferably also has a high thermal conductivity. In a further preferred embodiment, the sample inlet or the sample supply stream inlet is connected to a cooling device, such as a Peltier element, for the purpose of enriching, condensing, or separating gaseous sample vapors such as water vapor, essential oils, distillates, extracts, aerosols, via a thermal bridge. Via this thermal bridge, the sample inlet or the sample supply stream inlet can preferably be both heated and cooled. The inner surface of walls of the sample supply device, which comes into contact with the sample, should preferably be smooth, i.e., have a small effective surface area. By means of the cooling device, it is possible to promote the opposite effect of deposition or condensation for the purpose of enriching the sample. This can be desorbed independently in another process step by heating using the heating device.

Preferably, the first flow path comprises the homogenization device and/or the enrichment device.

According to one embodiment, the detection device comprises the homogenization device and/or the enrichment device. Preferably, the detection device comprises the heating device and/or the cooling device.

According to one embodiment, the detection device comprises a mixer, which is arranged between the mixing chamber stream outlet and the sample fluid inlet and is connected each of them in a fluid-conducting manner. The mixer is preferably a static mixer. To improve the mixing of the sample fluid stream, the diffusion path upon exit from the mixing chamber via the mixing chamber stream outlet can hereby be extended within a small volume using a static mixer, preferably in the embodiment as a spiral or screw (for example, Archimedean screw, similar to a wood screw or threaded screw), whereby more time is available for mixing. The static mixer in combination with the heating device can be connected to this heating device directly or via a thermal bridge; and it is particularly advantageous if the static mixer itself is the heating device, which, as previously mentioned, can be designed both as a resistance heater and as an inductive heater. The temperature of the sample fluid stream is advantageously measured using a temperature sensor, and adapted to the requirements and monitored using the control unit. Due to the thereby adjustable and controllable higher temperatures, an optimization of the diffusive mixing can be achieved, owing to the temperature dependency of the diffusion coefficients of both the dilution stream and the sample fluid stream. Due to the extended path, in particular in a spiral-shaped embodiment of the static mixer, an enriching of unmixed sample molecules on the surface of the mixer is also possible even in the mixing chamber stream outlet. In order to increase this accumulation effect, in a further embodiment, the static mixer is connected via a thermal bridge to the cooling device, such as a Peltier element. If the quantity accumulated on the surface is reached after a predetermined time, this can be heated by the heating device and thus the accumulated sample molecules can be released.

Preferably, the supplementary flow resistor or its walls can be heated by means of the heating device and/or cooled by means of the cooling device.

Preferably, the first flow path comprises a spiral-shaped or helical line section. In other words, a spiral-shaped or helical fluid-conducting element is arranged within the first flow path. This serves for the enrichment of fluid substances or of particles—in particular in combination with the heating and/or cooling device—with a high vapor pressure at low temperatures, which can be desorbed at higher temperatures. In special applications, the enlargement of the surface—in particular of the optional first flow resistor—of the first flow path into the mixing chamber is advantageous, in particular of the section of the flow-splitting device leading into the opening. This makes it possible to convert liquid components such as droplets in a gaseous sample, which are introduced directly from the environment, for example, as aerosols, or which can arise from condensation from a desorber or evaporator in the sample inlet, into the desired gaseous state of aggregation by heating by means of the heating device, before entry into the mixing chamber. In other words, the element is an insert of a spiral-like geometry, such as a screw or helix, for example, as a spring on a central guide axis, which completely or partially fills the interior space of the guiding flow path and, moreover, increases the flow resistance serially by extending the path. The first flow path leading into the mixing chamber or a part thereof is preferably itself designed as a spiral-shaped tube geometry or capillary, lengthening the path and enlarging the surface. These modifications to the inner surface in terms of increasing the flow resistance can also be used to separate larger particles from being transferred into the mixing chamber and practically to serve as a filter, in particular for solid particles. As an insert in the flow-guiding channel into the mixing chamber, this is preferably designed to be interchangeable and can thus be replaced or cleaned.

According to one embodiment, the control unit is connected to the heating device and/or the cooling device and is set up to control a heating power and/or a cooling power or to regulate it as a function of at least one operating variable of the sample fluid stream, the carrier stream, and/or the sample supply stream or of flow-guiding elements. In order to completely avoid deposits, condensations, or contaminations, for example on inner edges or bends with little flow where the fluid accumulates, such surfaces are additionally heated. A heating device, which provided for this purpose and regulated by the control unit, in conjunction with a temperature sensor for the first flow path fulfills this task. In this case, it is advantageous if the first flow path itself has a high thermal conductivity and low heat capacity, such as a thin-walled metallic capillary, which is connected to a heat-resistant and heat-insulating partition as a holder, for example, made of stainless steel or a plastic such as Teflon. Thus, the required temperature can be set with little delay and maintained with a low energy expenditure. In addition, the first flow path can be heated up separately and more quickly for cleaning at an increased temperature. In the embodiment with the flow-splitting device, it is advantageous for energy reasons to heat only the first section leading into the mixing chamber by means of the heating device, whereas the third flow path is thermally insulating. The heat is preferably supplied directly or indirectly, e.g. via a thermal bridge, resistively with a resistance winding or inductively by means of a coil.

Preferably, the operating variable is a mass fraction or mole fraction of the sample in a corresponding fluid stream. In other words, the physical variables such as concentration, temperature, pressure, and/or flow velocity are monitored and actively influenced in order to ensure a homogeneous distribution or targeted enrichment.

According to one embodiment, the operating variable is a predetermined volume or mass flow. The predetermined volume or mass flow is preferably based on a predetermined ratio of the volume or mass flow of the sample fluid stream and the volume or mass flow of the sample supply stream. Alternatively, the predetermined volume or mass flow is based on a predetermined ratio of the volume or mass flow of the dilution stream and the volume or mass flow of the sample supply stream.

According to one embodiment, the operating variable is a predetermined temperature of the carrier stream, the sample supply stream, and/or a surface temperature of flow-guiding elements. In other words, a regulation is then carried out as a function of a temperature value, preferably ascertained by a temperature sensor.

According to one embodiment, the control unit is set up to ascertain and set a manipulated variable of the heating device and/or the cooling device for controlling or regulating the heating power and/or cooling power. A manipulated variable is, for example, the supplied electrical power, provided that the device is electrically operated.

Preferably, the system further comprises a temperature sensor for acquiring the corresponding temperatures of the fluid streams or the surface temperature of flow-guiding elements. Thus, the heating temperature is preferably regulated to a target temperature by the control unit with the aid of the temperature sensor. In the case of gaseous fluids, the saturation vapor pressure and consequently the evaporation can then be controlled. Undesired deposits can also be removed using the heating device.

According to a preferred embodiment of the invention, the homogenization device and/or the enrichment device comprises the supplementary flow resistor or a part of the supplementary flow resistor. In other words, the homogenization device and/or the enrichment device form the supplementary flow resistor or the part of the supplementary flow resistor. This can take place, for example, by the heating device and/or the mixer in the case of the homogenization device. A composite of the components of the homogenization device accordingly forms the supplementary flow resistor or the part of the supplementary flow resistor. In the case of the enrichment device, this can take place, for example, by the cooling device. A composite of the components of the enrichment device accordingly forms the supplementary flow resistor or the part of the supplementary flow resistor.

According to one embodiment, the sample supply device and/or the detection device comprises a filter for cleaning the fluid streams. In this case, the first flow path preferably comprises a particle filter. The particle filter is arranged as a, preferably replaceable, insert in the sample inlet. Alternatively, the particle filter is arranged between the sample inlet and the sample supply stream inlet, preferably in a cylindrical transition channel, and is connected to these in each case in a fluid-conducting manner. When the filter is used in the detection device for specifically gaseous fluids, the dilution stream preferably flows through an upstream drying filter such as a molecular sieve before entering the mixing chamber. In other words, the detection device comprises a filter for removing remaining portions of the sample from the detection loop, which is arranged between the fluid outlet and the dilution stream inlet and is connected to these in each case in a fluid-conducting manner. Thereby, an improved detection sensitivity is achieved, and remaining components from previous measurements that would falsify an evaluation are prevented. The sample fluid stream enters the sample chamber via the mixing chamber stream outlet. Accordingly, the dilution stream inlet as well as the mixing chamber stream outlet are preferably expanded with additional functional elements. Thus, a filter such as a drying filter or molecular sieve is arranged upstream of the dilution stream inlet. As is known, undesired foreign particles such as dust or liquid components such as (fog) droplets or aerosols in a gaseous sample can also enter the detection device during sample intake. For separation or deposition, a particle filter integrated as a trap, which is designed for example as a sieve or a frit, is preferably located in the sample inlet. This is advantageously designed as an replaceable insert in the sample inlet or in a cylindrical transition channel opening to the mixing chamber.

In an advantageous embodiment, the system comprises a third conveyor for conveying a purge stream from the sample outlet to the sample inlet. The third conveyor is preferably arranged upstream of the sample outlet or downstream of the sample inlet relative to a flow direction of the purge stream and is connected to the sample outlet or the sample inlet in a fluid-conducting manner. The third conveyor is designed to move the purge stream from the sample outlet to the sample inlet. In the operating mode “back-purging”, the flow direction is reversed so that the purge stream from the sample outlet in the direction of the sample inlet is carried out with a fluid that is as sample-free as possible. The part of the arrangement conveying the sample can be used for cleaning the sample-guiding channels by reversing the conveying direction of the original carrier stream from the sample outlet in the direction of the sample inlet, wherein a sample-free fluid, for example, the originally sample-guiding fluid cleaned by means of a filter, is used for purging. A procedural special case during the purging is that the sample supply into the mixing chamber is completely blocked, i.e., the optional first and/or second flow resistor is very large. This means that at least one of the first and second flow resistor is significantly larger than the splitting flow resistor, preferably more than 100 times larger. In this case, no equalizing stream flows either. The detection loop is maintained, which is advantageous for the cleaning of the mixing chamber.

According to one embodiment, the sample supply device comprises a filter and/or a heating device for the purge stream. Preferably, the purge stream is heated by a wall in the vicinity of the sample outlet using the heating device, the temperature of which is preferably measured with a temperature sensor and regulated with the control unit. In contrast to a membrane inlet, with the dosing device with the features identified previously, the maximum temperature for baking out is not limited by the limitation of the membrane, such as a maximum temperature of for example 80° C., but rather by the material of the flow-guiding walls, such as stainless steel or heat-resistant plastic such as Teflon, so that higher temperatures such as 200° C. are also possible for cleaning. Since the third conveyor is preferably arranged on the input side relative to the purge stream, it cannot be damaged by the hot fluid stream either.

In a further advantageous embodiment, the mixing chamber comprises a partition, in which the sample supply stream inlet and the equalizing stream outlet are arranged. The previously described optional supplementary flow resistor is preferably integrated into the partition, for example, in the form of a flow orifice.

According to one embodiment of the invention, the first and/or the second flow path are connected at least partially detachably to the mixing chamber, preferably to the partition.

In a further preferred embodiment, the sample supply device further comprises a sample pre-chamber, which forms at least a part of the first flow path. In other words, the system further comprises a sample pre-chamber, which is connected to the sample inlet and the sample supply stream inlet in a fluid-conducting manner. Accordingly, the first flow path comprises a sample pre-chamber. In other words, the sample is thus guided via the sample inlet into the sample pre-chamber by means of the second conveyor, in which said sample can be collected, buffered, or enriched. From this, the sample enters the mixing chamber directly and completely or, via the optional flow-splitting device, proportionally into the mixing chamber and the remaining portion into the sample outlet.

According to one embodiment, the sample pre-chamber is mechanically connected directly to the mixing chamber, preferably via the partition, which comprises the sample supply stream inlet and the equalizing stream outlet. Alternatively, the sample pre-chamber is connected indirectly to the mixing chamber by lines of the first flow path. The sample inlet and the mixing chamber, or the sample pre-chamber and the mixing chamber are accordingly separated from one another by a partition, which is preferably designed as a disk, in which at least one opening forming the sample supply stream inlet and at least one opening forming the equalizing stream outlet are provided. The partition enables a modular structure, with which elements for sample supply, in particular the sample supply device, can be detached from the partition. Hereby, in the event of a possible contamination, components are connected to the sample inlet can be detached via a detachable connection such as a plug-in, screw-in or bayonet connection, and thus the sample-guiding walls can be cleaned mechanically by “scrubbing” and/or chemically. The partition also serves to functionally separate the sample inlet and mixing chamber. Particularly advantageously, due to the modular structure, the part of the optional flow-splitting device branching into the mixing chamber can be plugged sealingly into the partition and adapted to different flow conditions and removed for cleaning if necessary. In this case, the equalizing stream preferably takes place via at least one equalizing stream outlet designed as a bore with an optional supplementary second flow resistor.

Preferably, the sample pre-chamber further forms at least a part of the second flow path. In other words, the second flow path comprises the sample pre-chamber. Here, the sample pre-chamber is connected to the equalizing stream outlet and the sample outlet in a fluid-conducting manner.

According to one embodiment, the flow-splitting device or its branches are arranged in, before, or after the sample pre-chamber. The equalizing stream outlet preferably opens into the sample pre-chamber, wherein the sample pre-chamber itself then forms or comprises the flow-splitting device. In this case, there is a direct connection to the first flow path and the second flow path, so that the first partial carrier stream flows further along the first flow path in the direction of the sample supply stream inlet and the second partial carrier stream flows along the third flow path to the second flow path. The third flow path and at least a part of the second flow path are then formed by the sample pre-chamber. Alternatively, the equalizing stream outlet can be guided via a separate line inside or outside the sample pre-chamber by means of the second flow path, in which case a flow-splitting device does not have to be present. However, a connecting line can be provided from the separate line guided inside or outside into the sample pre-chamber. Here, the second branch of the flow-splitting device is then simply provided by this connecting line to the second flow path and the interior space of the sample pre-chamber. The first flow path can comprise a tube section extending into the sample pre-chamber or have an opening of the sample pre-chamber. The flow-splitting device can also be provided before or after the sample pre-chamber.

A preferred embodiment of the flow-splitting device comprises two interlocking coaxial cylindrical tubes. The inner tube, leading via the sample supply stream inlet into the mixing chamber, is part of the first flow path and has the first flow resistor. This can be realized by a plurality of parallel supply lines into the mixing chamber, for example, as bores in the optional partition to the mixing chamber and/or tube-like channels from the mixing chamber. Preferably, the inner tube is a capillary with a smaller wall thickness than the outer tube and has a smaller volume, so that a low mass and heat capacity and consequently a short warm-up time are present. The outer tube is part of both the second flow path and the third flow path and comprises the splitting flow resistor. It can preferably be extended to the sample pre-chamber and, on the other hand, leads to the sample outlet. The flow split of the flow-splitting device is determined by the first flow resistor and the splitting flow resistor of the two tubes, which, as is known, in the case of a cylindrical geometry, depend on both the flow cross-section and the channel length. If the sample flow through the sample inlet is large, for example due to strong suction, then a large portion must be guided by the flow splitter via the third flow path to the sample outlet. In this case, the first flow resistor and/or the second flow resistor from the mixing chamber via the equalizing stream outlet to the sample outlet is much larger than the splitting flow resistor, but at least 10 times larger. The splitting flow resistor from the sample inlet to the sample outlet is preferably left unchanged, so that the flow split is determined by the dimensioning of the first and second flow resistor.

In an advantageous embodiment, the system further comprises a housing with a partition, which is designed to form the mixing chamber and the sample pre-chamber.

Preferably, the partition comprises at least a first opening forming the sample supply stream inlet and/or at least a second opening forming the equalizing stream outlet.

In a further preferred embodiment of the invention, it is provided that at least a part of the fluid-conducting inner surfaces of the first flow path is smooth and/or inert to a reaction with the sample. For this purpose, the inner surfaces have a surface with an absolute roughness k of less than 0.03 mm. The absolute roughness k is preferably smaller than 0.02 mm, preferably smaller than 0.01 mm, and particularly preferably smaller than 0.007 mm. Roughness measurements of surfaces are possible in the form of line profiles and as planar, three-dimensional roughness measurements. The measurement is preferably carried out by means of a profilometer probe according to DIN EN ISO 25178. The evaluation of profilometric analyses is regulated in the standards DIN EN ISO 4287 for line profiles and DIN EN ISO 25178 for three-dimensional roughness measurements of surfaces. The parameters of the roughness measurement are also specified in the standards. ISO 25178 defines the surface-related roughness value Sa or Ra via the arithmetic mean of the topography height z(x,y). A suitable optical measurement method is confocal microscopy. The surface roughness value Sa can be smaller than 0.04 mm, smaller than 0.03 mm, and smaller than 0.01 mm. This helps in the avoidance of deposits. They should be inert to the reaction with the sample fluid. This also permits simple cleaning of the surface.

Preferably, at least a part of fluid-conducting inner surfaces of the first flow path has a coating of Teflon and/or silicate.

Preferably, at least a part of the first flow path comprises or consists of a heat-resistant material, which has a resistance to high temperatures of more than 80° C., preferably more than 130° C., and particularly preferably more than 160° C.

Preferably, the heat-resistant material is Teflon, stainless steel, and/or a passivated metal.

In a preferred embodiment of the invention, it is provided that the sample supply device comprises a substance-specific time filter device, which is designed such that, in a continuous operation of the system, different substances contained in the sample are acquired by the detection device at different points in time.

In an advantageous embodiment, the substance-specific time filter device comprises at least a part of fluid-conducting inner surfaces of the first flow path, which have a coating, wherein the coating is designed such that different substances contained in the sample (reversibly) interact with the coating in a substance-specific and/or catalytic manner (adsorption and desorption).

Preferably, the substance-specific time filter device is combined with a temperature regulating means for the coating (see preceding explanations) in order to realize a substance-specific time filter, and the temporal differences measured herewith during a detection can be used as an independent dimension for evaluating the spectra or the detector or sensor values by means of a controller or computer.

According to a further advantageous embodiment, the detection device comprises an ion mobility spectrometer, IMS, for ascertaining an ion mobility of a sample, wherein the sample chamber comprises a cylindrical drift space designed for the transport of ions from a switching grid to an ion detector against an axial drift fluid flow. In this case, the ion mobility spectrometer further has a cylindrical reaction space adjoining the drift space in an axial direction, which has the sample fluid inlet adjacent to the switching grid for introducing the sample fluid stream, wherein the fluid outlet for discharging drift fluid and sample fluid is arranged adjacent to the switching grid. Furthermore, the ion mobility spectrometer has an ionization source arranged at the fluid outlet, wherein the sample inlet is connectable, in a fluid-conducting manner, to an environment or a desorber for receiving the sample. In the case of an ion mobility spectrometer, there is then the advantage that both higher-molecular substances and lower-molecular substances in the carrier fluid can be detected in a comparably short time.

In an advantageous embodiment of the invention, the control unit is further set up to receive a signal value from the detection device, in particular from a detector of the detection device such as an ion detector or a radiation detector, an ion detector arranged in a drift space of the IMS, and to regulate the conveying capacity of the first conveyor, the conveying capacity of the second conveyor, and/or the supplementary flow resistor depending on the signal value. In other words, the operating variable comprises a signal value or a sequence of signal values of the detector of the detection device. The sequence of signal values can include a spectrum or a sequence of spectra and values calculated therefrom.

The invention further relates to a sample receiving device for receiving and dosing a sample for the system according to the invention, comprising: the mixing chamber for mixing the dilution stream and the sample supply stream, which has the sample supply stream inlet and the equalizing stream outlet, as well as the dilution stream inlet and the mixing chamber stream outlet, wherein the dilution stream inlet is connectable to the fluid outlet of the detection device for analyzing the sample in a fluid-conducting manner and the mixing chamber stream outlet is connectable to the sample fluid inlet of the detection device for analyzing the sample in a fluid-conducting manner to form the detection loop. The sample receiving device further comprises the sample supply device comprising the sample inlet, which is connected to the sample supply stream inlet in a fluid-conducting manner by means of a first flow path for introducing the sample into the system, and the sample outlet, which is connected to the equalizing stream outlet in a fluid-conducting manner by means of the second flow path, and the second conveyor for conveying the carrier stream containing the sample from the sample inlet to the sample outlet.

The invention further relates to a method for supplying and analyzing a sample contained in a sample fluid stream using a system according to the invention. The method comprises introducing the carrier stream laden with the sample via the sample inlet by the second conveyor for conveying the carrier stream from the sample inlet to the sample outlet, and introducing the sample supply stream into the mixing chamber via the sample supply stream inlet by means of the first flow path. Furthermore, the method comprises a step of introducing the dilution stream into the mixing chamber via the dilution stream inlet through the detection loop driven by the first conveyor, as well as a step of discharging the equalizing stream from the mixing chamber via the equalizing stream outlet by means of the second flow path. Furthermore, the sample fluid stream is discharged from the mixing chamber via the mixing chamber stream outlet through the detection loop driven by the first conveyor and the carrier stream is removed via the sample outlet by the second conveyor for conveying the carrier stream from the sample inlet to the sample outlet take place.

The various embodiments of the invention mentioned in this application can be advantageously combined with one another, unless otherwise specified in the individual case.

### BRIEF DESCRIPTION OF THE DRAWINGS

The invention is explained in more detail below using an exemplary embodiment and associated drawings. The figures show:

FIG. 1 schematic structure of a system for detecting and analyzing a sample contained in a sample fluid stream according to the invention,

FIG. 2 simplified structure of a system for detecting and analyzing a sample contained in a sample fluid stream according to the invention,

FIG. 3 schematic representation of a flow system of a system for detecting and analyzing a sample contained in a sample fluid stream according to the invention.

### DETAILED DESCRIPTION

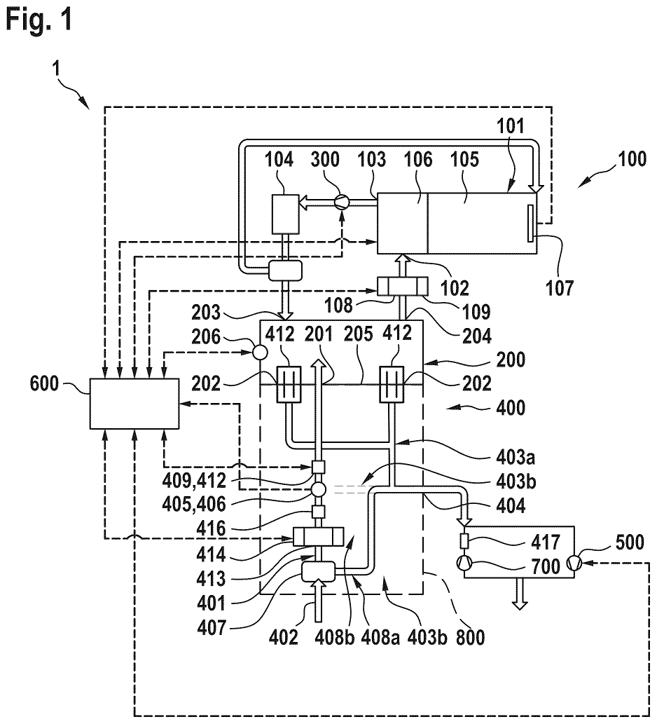

FIG. 1 shows a schematic structure of a system 1 for detecting and analyzing a sample contained in a sample fluid stream according to the invention. The system comprises a detection device 100 for analyzing the sample, wherein the detection device 100, which in the present case is exemplarily an ion mobility spectrometer, includes a sample chamber 101 with a sample fluid inlet 102 for supplying the sample fluid stream and a fluid outlet 103, into which the sample is introduced for analysis. The system 1 further comprises a mixing chamber 200 for mixing a dilution stream and a sample supply stream, which has a sample supply stream inlet 201 and an equalizing steam outlet 202, as well as a dilution stream inlet 203 and a mixing chamber stream outlet 204, wherein the dilution stream inlet 203 is connected to the fluid outlet 103 in a fluid-conducting manner and the mixing chamber stream outlet 204 is connected to the sample fluid inlet 102 in a fluid-conducting manner to form a detection loop. Furthermore, the system 1 has a first conveyor 300, which is designed to drive the detection loop for conveying the sample fluid stream, and a sample supply device 400 comprising a sample inlet 402, which is connected to the sample supply stream inlet 201 in a fluid-conducting manner by means of a first flow path 401 for introducing the sample into the system 1, and a sample outlet 404, which is connected to the equalizing steam outlet 202 in a fluid-conducting manner by means of a second flow path 403a, 403b. The system further comprises a second conveyor 500 for conveying a carrier stream containing the sample from the sample inlet 402 to the sample outlet 404.

The sample chamber 101 comprises a cylindrical drift space 105 designed for the transport of ions from a switching grid to a detector, specifically an ion detector, 107 against an axial drift fluid flow. In this case, the ion mobility spectrometer further has a cylindrical reaction space 106 adjoining the drift space 105 in an axial direction, which has the sample fluid inlet 102 adjacent to the switching grid for introducing the sample fluid stream, wherein the fluid outlet 103 for discharging drift fluid and sample fluid is arranged adjacent to the switching grid. Furthermore, the ion mobility spectrometer has an ionization source arranged at the fluid outlet 103.

The system 1 further comprises a control unit 600, which is connected to the first conveyor 300 and to the second conveyor 500 in a signal-conducting manner and is set up to regulate a first conveying capacity of the first conveyor 300, and a second conveying capacity of the second conveyor 500.

Furthermore, the control unit is connected to further components, as illustrated in FIG. 1 by dashed connecting lines. The connection between the control unit 600 and one of the controlled components is designed differently depending on the system and serves for regulation, monitoring, and communication. Preferably, the control unit 600 takes over central control and regulation tasks by sending signals to the corresponding component in order to adjust or control its operation. These include commands such as start, stop, or changes to specific operating parameters. Alternatively, one or more of the present components are also equipped with a separate, independent control unit, which is directly matched to specific requirements. Preferably, the corresponding component reports data, such as operating states or (environmental) parameters, back to the control unit 600 via sensors or other acquisition systems. This information enables precise monitoring of the system and/or dynamic adjustment of the control system. In more complex systems, such as in a closed control loop, a continuous comparison takes place between the current operating data and the target specifications, whereby optimal function is ensured. The communication between the control unit 600 and the corresponding component thus preferably takes place in both directions. Control commands flow from the control unit 600 to the component, while feedback is transmitted from the component to the control unit 600. The signal-conducting connection is shown in the present case by the dashed connecting lines between the control unit 600 and the corresponding components. An arrow originating from the control unit 600 in the direction of the components connected to the control unit shows the direction of signals originating from the control unit 600 to the corresponding component. An arrow originating from the respective component in the direction of the control unit connected to this component shows the direction of signals originating from the component to the control unit 600.

Depending on the system design, the connection can also comprise energy supply, which is provided by the control unit 600 or an assigned source. This flexibility allows the use of both centralized and decentralized control solutions.

The system 1 further comprises pressure sensors 405 for acquiring and ascertaining a differential pressure of a fluid stream of the sample supply stream and the equalizing stream, which are connected to the control unit 600.

The mixing chamber preferably comprises sensors 206 for temperature, pressure, and/or composition. Hereby, the corresponding states within the mixing chamber can be monitored. The sensors 206 are connected to the control unit 600.

The system 1 further comprises a flow-splitting device 407, which is designed to split the carrier stream into a first partial carrier stream along the first flow path 401 to the sample supply stream inlet 201 and a second partial carrier stream along a third flow path 408a, 408b, which is connected to the first and the second flow path 401, 403a, 403b in a fluid-conducting manner, to the sample outlet 404. In other words, the system 1 further comprises a third flow path 408a, 408b for splitting the carrier stream into at least two partial carrier streams, wherein the third flow path 408a, 408b is connected in a fluid-conducting manner to the first flow path 401 by means of a first branch and is connected in a fluid-conducting manner to the second flow path 403a, 403b by means of a second branch. Hereby, the first partial carrier stream can flow along the first flow path 401 in the direction of the sample supply stream inlet 201 and flow into it, whereas the second partial carrier stream can flow along the third flow path 408a, 408b in the direction of the second flow path 403a, 403b and flow into it.

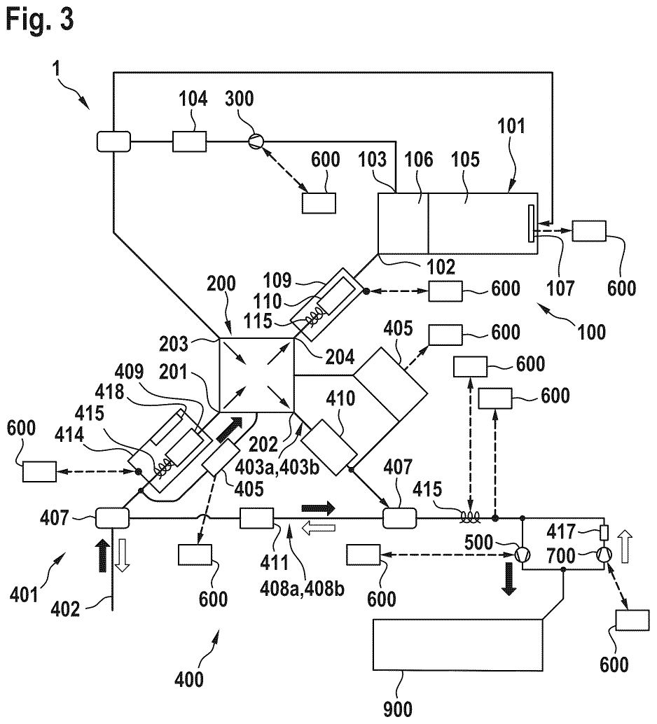

The first flow path 401 comprises a supplementary first flow resistor 409 and the second flow path 403a, 403b comprises a supplementary second flow resistor 410 (see FIG. 3). According to one embodiment, the third flow path 408a, 408b comprises a supplementary splitting flow resistor 411 (see FIG. 3).

In the present case, the first flow resistor 409 is adjustable by an actuating mechanism 412. The first flow resistor 409 is automatically adjustable by the control unit 600 connected to the actuating mechanism 412. The control unit 600 is connected to the actuating mechanism 412 and is set up to control the first flow resistor 409, or to regulate it preferably as a function of an operating variable of the carrier stream and/or the sample supply stream.

The sample supply device 400 comprises a homogenization device 414 and an enrichment device 413. The homogenization device 414 comprises in the present case a heating device 415 and a supplementary flow resistance 409 (see FIG. 3), and the enrichment device 413 comprises in the present case a cooling device. Optionally, the homogenization device 414 of the sample supply device can also comprise an additional mixer (not shown), which ensures a further uniform distribution of components of the fluid streams in the sample supply device 400. The detection device 100 also comprises a homogenization device 109 and an enrichment device 108. The homogenization device 109 is in the present case a heating device and the enrichment device 108 is in the present case a cooling device. Furthermore, the homogenization device 109 of the detection device 100 also preferably comprises a mixer (not shown), which ensures a further uniform distribution of components of the sample fluid stream in the detection device 100. The control unit 600 is connected to the previously mentioned components and is set up to activate and deactivate a function of the enrichment devices 108, 413 and the homogenization devices 109, 414, and in particular to control an enrichment performance of the enrichment devices 108, 413 and a homogenization performance of the homogenization devices 109, 414 or to regulate them depending on an operating variable of the sample fluid stream or the sample supply stream.

The system 1 further comprises a temperature sensor 406 for acquiring the temperatures of the sample supply stream, which is likewise connected to the control unit 600.

The sample supply device 400 comprises a filter 416 for cleaning the sample supply stream. The detection device also comprises a filter for cleaning the dilution stream 104.

The system comprises a third conveyor 700 for conveying a purge stream from the sample outlet 404 to the sample inlet 402. The third conveyor 700 is arranged upstream of the sample outlet 404 with respect to a flow direction of the purge stream and is connected to the sample outlet 404 in a fluid-conducting manner. In addition, the sample supply device 400 comprises a filter 417 for cleaning a purge stream during an operating mode “purging”.

Furthermore, the sample supply device 400 comprises a sample pre-chamber 800, which forms at least a part of the first flow path 401. In other words, the system further comprises a sample pre-chamber 800, which is connected in a fluid-conducting manner to the sample inlet 402 and the sample supply stream inlet 203. In the present case, some previously described components of the sample supply device 400 are arranged within the sample pre-chamber 800 according to FIG. 1. Accordingly, it is possible that these components lie in a free flow of the carrier stream or are connected by means of fluid-conducting connecting lines. In the second case, then there is at least one opening for connection to the sample pre-chamber 800, which can be present on the input side of the connected components or on the output side thereof.

The system comprises a housing with a partition 205, which is designed to form the mixing chamber and the sample pre-chamber. The sample supply stream inlet 201 and the equalizing stream outlet 202 are arranged in the partition 205.

Furthermore, there are various possibilities for implementing the flow-splitting device 407. For example, upon introduction of the carrier stream with a pipe section, a line can branch off from this pipe section as a third flow path 408a. The flow path 408a then opens into the second flow path 403a upstream of the sample outlet 404, which second flow path thus likewise must comprise at least one line connected to the sample outlet 404. Alternatively, the carrier stream can open into the sample pre-chamber 800, wherein the third flow path 408b is formed at least partially by an interior space of the sample pre-chamber 800. The second flow path 403b can then either comprise a line having an opening to the interior space of the sample pre-chamber 800, so that the connection to the third flow path 408b takes place via this line or comprise no lines at all, so that the second and third flow path 403b, 408b are formed by the interior space.

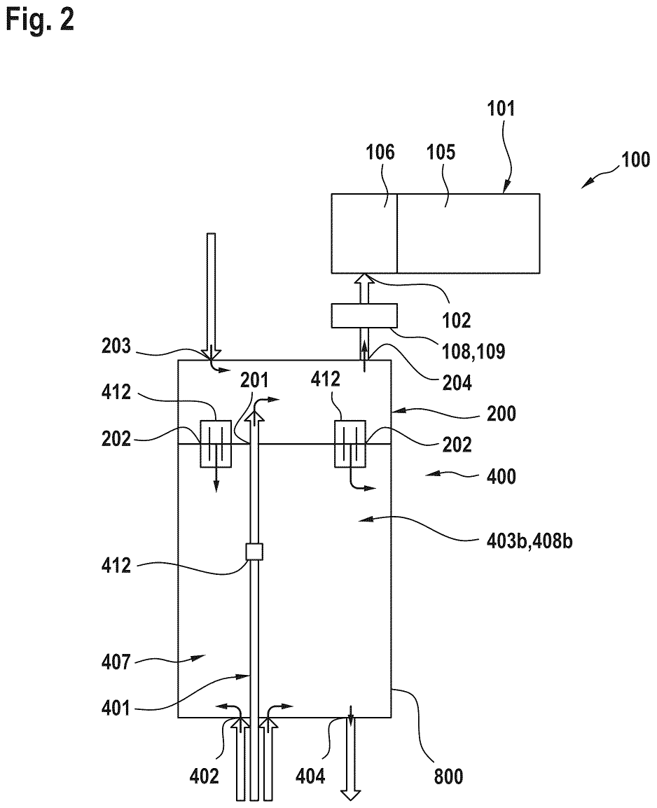

FIG. 2 shows a simplified structure of a system 1 for detecting and analyzing a sample contained in a sample fluid stream according to the invention. Elements corresponding to components described in FIG. 1 will not be explained again, and the corresponding description with reference to FIG. 1 is to be applied to them. Here, a variant of the flow-splitting device 407 is shown, in which the carrier stream enters the sample pre-chamber 800 and flows there with a first partial carrier stream along the first flow path 401, which is formed by the interior space of the sample pre-chamber 800, in the direction of the sample supply stream inlet 201 and via this sample supply stream inlet, enters the mixing chamber 200 as a sample supply stream. A second partial carrier stream flows along the third flow path 408b, which is likewise formed by the interior space of the sample pre-chamber 800, in the direction of the second flow path, which in turn is also formed by the interior space of the sample pre-chamber 800, merges with the equalizing stream to form the carrier stream, which leaves the system via the sample outlet 404. The arrows only indicate the fluid streams and are not to be understood as lines in the present case.

FIG. 3 shows a schematic representation of a flow system of a system 1 for detecting and analyzing a sample contained in a sample fluid stream according to the invention. Elements corresponding to components described in FIG. 1 will not be explained again, and the corresponding description with reference to FIG. 1 is to be applied to them. This also applies to the control unit 600, which is shown as separate units in the present case for reasons of clarity. As explained previously, the use of one or more control units is possible. The same applies also to the connections between the control unit 600 and corresponding components of the system 1, which are again shown as dashed lines with the corresponding arrow directions. The first flow path 401 comprises a supplementary first flow resistor 409 and the second flow path 403a, 403b comprises a supplementary second flow resistor 410. According to one embodiment, the third flow path 408a, 408b comprises a supplementary splitting flow resistor 411. The embodiment can take place both with and without the sample pre-chamber 800. Likewise, the flow paths 401, 403a, 403b, 408a, 408b can be designed differently, be it through lines or channels or an interior space of the sample pre-chamber 800. Furthermore, it can be seen how multiple pressure sensors 405 acquire the differential pressure at two points by means of supply lines in order to transmit it to the control unit 600, which can thereby fulfill its respective regulation function.

The sample is preferably conveyed via the flow-splitting device 407 either completely or proportionally convectively via the sample supply stream inlet 201 of the mixing chamber and via the mixing chamber stream outlet 204 to the detection device 100 as well as in the direction of the sample outlet 404. In this case, the first partial carrier stream (i.e., the sample supply stream) that has entered the mixing chamber 200 is mixed with the fluid stream from the dilution stream inlet 203 and is conveyed convectively as a combined stream or sample fluid stream to the mixing chamber stream outlet 204. In other words, a combination of the flow-splitting device 407 and the first and second flow resistor 409, 410 as well as the splitting flow resistor 411 is particularly advantageous. Hereby, the sample flow from the sample inlet 402 is split into the first partial carrier stream and the second partial carrier stream by means of the first flow resistor 409 and the splitting flow resistor 411. Alternatively, the flow split can also take place on the output side by means of the splitting flow resistor 411 and the second flow resistor 410. Likewise, the flow split is possible with all supplementary flow resistors. The dimensioning of the flow splitter via these flow resistors depends on the desired proportional sample flow into the mixing chamber. With a fixed choice of the flow resistors, the inflow from the second conveyor can be varied within certain limits. Alternatively, the flow resistors are also adjustable, wherein they are then changed via the actuating mechanism 412 (not shown), which is connected to the control unit 600. The filled arrows represent the flow direction in the operating mode “dosing”, whereas the unfilled arrows represent the flow direction in the operating mode “purging”.

The detection device 100 comprises a static mixer 110, which is arranged between the mixing chamber stream outlet 204 and the sample fluid inlet 102 and is connected to these in each case in a fluid-conducting manner. Particularly advantageous is a combination of a heating device 115, which can be designed both as a resistance heater and as an inductive heater, and a mixer 110, by which the diffusive mixing in the mixer 110 is promoted with the heating device. According to one embodiment, the mixer 110 then itself comprises the heating device. Accordingly, it can be formed by the shaping heating elements, so that it combines both functionalities in itself. Alternatively, the mixer 110 can be heated by the homogenization device 109, which is designed in the present case as a heating device.

Furthermore, the sample supply device 400 optionally comprises an enrichment device, which in the present case comprises a cooling device 418 such as a Peltier element for the purpose of enrichment or condensation or separation of gaseous sample vapors such as water, which is optionally connected via a thermal bridge to the first flow path 401. In addition, the sample supply device 400 comprises a homogenization device 414, preferably in the form of the supplementary flow resistor 409 in combination with a heating device 415, which is arranged between the sample inlet 402 and the sample supply stream inlet 201. In the present case, the homogenization device 414 and the cooling device 418 are designed as one integral element. Alternatively, it is also possible for the homogenization device 414 and the cooling device 418 to be present as separate elements. According to one embodiment, the heating device and the cooling device 418 are preferably connected to the first flow path 401 via a thermal bridge (not shown). The homogenization device 414, for example in the form of the flow resistor 409 and the heating device 415, is particularly advantageously arranged downstream of the flow-splitting device 407 and upstream of the sample supply stream inlet 201. The same applies to the enrichment device, for example in the form of the cooling device 418, such as the Peltier element. Via the thermal bridge, the first flow path 401 can preferably be both heated and cooled. Optionally, the homogenization device 414 comprises, besides the heating device 415, a mixer (not shown). This is particularly advantageously suitable for the investigation of fluids such as aerosols. The mixing of aerosols by the mixer is carried out by uniformly distributing the carrier medium (e.g., the carrier stream or the sample supply stream) and the suspended particles through mechanical action, such as vortex generation or turbulent flows. The mixer of the sample supply device 400 ensures that particles remain homogeneously distributed and inhomogeneities are minimized. Here, factors such as the particle size, flow velocity, and the geometry of the mixer influence the mixing efficiency. Hereby, the mixing with the dilution stream in the mixing chamber is consequently promoted.

The homogenization devices 109, 414 in the present case each comprise a heating device 415, 115. In the present case, the homogenization device 414 of the sample supply device 400 further comprises the supplementary flow resistor 409. The homogenization device 109 of the detection device 100 further comprises a mixer 110 as well as the heating device 115.

The supplementary flow resistor, in particular the supplementary first flow resistor 409, can preferably be tempered to a predetermined operating temperature by means of the heating device 415. This can be achieved, in the present case, by the homogenization device 414 comprising the heating device 415. Alternatively, a separate heating device such as a heating spiral, heating coil or inductive heating is provided, which heats the supplementary flow resistor 409 and in particular its flow-guiding walls, independently of other processes. Such a heating device is optionally also provided for the supplementary second flow resistor 410 and/or the splitting flow resistor 411, but can also be omitted. The lines and channels can also be cleaned during a back-purging.

In an advantageous embodiment, the system comprises a third conveyor 700 for conveying a purge stream from the sample outlet 404 to the sample inlet 402. The third conveyor 700 is arranged upstream of the sample outlet 404 and is connected to the sample outlet 404 in a fluid-conducting manner. The third conveyor 700 is designed to move the purge stream from the sample outlet 404 to the sample inlet 402. In the operating mode “back-purging”, the flow direction is reversed so that the purge stream from the sample outlet 404 in the direction of the sample inlet 402 is carried out with a fluid that is as sample-free as possible. A procedural special case during the purging is that the sample supply into the mixing chamber 200 is completely blocked, i.e., the optional first and/or second flow resistor 409, 410 is very large. This means that at least one of the first and second flow resistor 409, 410 is significantly larger than the splitting flow resistor 411, preferably more than 100 times larger. In this case, no equalizing stream flows either. The detection loop is maintained, which is advantageous for the cleaning of the mixing chamber. The operating mode “purging” or the flow direction occurring in this case is represented by the unfilled arrows. The operating mode “dosing” or the flow direction occurring in this case is represented by the filled arrows.

The sample supply device comprises a filter 417 and a further heating device 415 for the purge stream, which is arranged between the equalizing stream outlet 202 and the sample outlet 404. Preferably, the purge stream is heated by a wall in the vicinity of the sample outlet 404 using the heating device 415, the temperature of which is preferably measured with a temperature sensor (not shown) and regulated with the control unit 600.

### LIST OF REFERENCE SIGNS

1 System
100 Detection device
101 Sample chamber
102 Sample fluid inlet
103 Fluid outlet
104 Filter
105 Drift space
106 Reaction space
107 Detector, specifically ion detector
108 Enrichment device
109 Homogenization device
110 Mixer
115 Heating device
200 Mixing chamber
201 Sample supply stream inlet
202 Equalizing steam outlet
203 Dilution stream inlet
204 Mixing chamber stream outlet
205 Partition
206 Sensors
300 First conveyor
400 Sample supply device
401 First flow path
402 Sample inlet
403a, 403b Second flow path
404 Sample outlet
405 Pressure sensor
406 Temperature sensor
407 Flow-splitting device
408a, 408b Third flow path
409 Supplementary first flow resistor
410 Supplementary second flow resistor
411 Supplementary third flow resistor
412 Actuating mechanism
413 Enrichment device (Cooling device)
414 Homogenization device (Mixer)
415 Heating device
416, 417 Filter
418 Cooling device
500 Second conveyor
600 Control unit
700 Third conveyor
800 Sample pre-chamber
900 Environment

1. A system for detecting and analyzing a sample contained in a sample fluid stream, the system comprising:
a detection device comprising a sample chamber with a sample fluid inlet for supplying the sample fluid stream and a fluid outlet, into which the sample is introduced for analysis;
a mixing chamber for mixing a dilution stream and a sample supply stream, the mixing chamber comprising a sample supply stream inlet and an equalizing steam outlet, a dilution stream inlet, and a mixing chamber stream outlet, wherein the dilution stream inlet is connected to the fluid outlet in a fluid-conducting manner and the mixing chamber stream outlet is connected to the sample fluid inlet in a fluid-conducting manner to form a detection loop,
a first conveyor configured to drive the detection loop for conveying the sample fluid stream,
a sample supply device comprising a sample inlet, which is connected to the sample supply stream inlet in a fluid-conducting manner by means of a first flow path for introducing the sample into the system, and a sample outlet connected to the equalizing steam outlet in a fluid-conducting manner by means of a second flow path, and
a second conveyor for conveying a carrier stream containing the sample from the sample inlet to the sample outlet.

2. The system of claim 1, further comprising a control unit connected to the first conveyor and/or the second conveyor and is set up to control or regulate a first conveying capacity of the first conveyor and/or a second conveying capacity of the second conveyor.

3. The system of claim 1, wherein the sample supply device further comprises a flow-splitting device, which is designed to split the carrier stream into a first partial carrier stream along the first flow path to the sample supply stream inlet and a second partial carrier stream along a third flow path, that is connected to the first and to the second flow path in a fluid-conducting manner, to the sample outlet.

4. The system of claim 1, wherein the sample supply device further comprises at least one supplementary flow resistor.

5. The system of claim 1, further comprising:
an enrichment device for enriching the sample in the sample fluid stream, carrier stream, and/or sample supply stream, and/or
a homogenization device for mixing the sample in the sample fluid stream, carrier stream, and/or sample supply stream and/or for reducing condensation of the sample.

6. The system of claim 1, further comprising a third conveyor for conveying a purge stream from the sample outlet to the sample inlet.

7. The system of claim 1, wherein the mixing chamber further comprises a partition, in which the sample supply stream inlet and the equalizing steam outlet are arranged.

8. The system of claim 1, wherein the first and/or the second flow path are connected at least partially detachably to the mixing chamber.

9. The system of claim 1, wherein the sample supply device further comprises a sample pre-chamber, that forms at least a part of the first flow path.

10. The system of claim 1, further comprising a housing with a partition configured to form the mixing chamber and the sample pre-chamber.

11. The system of claim 1, wherein at least a part of the fluid-conducting inner surfaces of the first flow path is smooth and/or inert with respect to a reaction with the sample.

12. The system of claim 1, wherein the sample supply device further comprises a substance-specific time filter device, that is configured such that, in a continuous operation of the system, different substances contained in the sample are acquired by the detection device at different points in time.

13. The system of claim 1, wherein the detection device further comprises an ion mobility spectrometer for ascertaining an ion mobility of a sample, wherein the sample chamber comprises a cylindrical drift space designed for the transport of ions from a switching grid to an ion detector against an axial drift fluid flow, the ion mobility spectrometer further comprising:
a cylindrical reaction space adjoining the drift space in an axial direction, that has the sample fluid inlet adjacent to the switching grid for introducing the sample fluid stream, wherein the fluid outlet for discharging drift fluid and sample fluid is arranged adjacent to the switching grid, and
a local ionization source arranged at the fluid outlet,
wherein the sample inlet is connectable to an environment or a desorber for receiving the sample in a fluid-conducting manner.

14. A sample receiving device for receiving and dosing a sample for the system of claim 1, the sample receiving device comprising:
the mixing chamber for mixing the dilution stream and the sample supply stream, which has the sample supply stream inlet and the equalizing steam outlet, as well as the dilution stream inlet and the mixing chamber stream outlet, wherein the dilution stream inlet is connectable to the fluid outlet of the detection device for analyzing the sample in a fluid-conducting manner and the mixing chamber stream outlet is connectable to the sample fluid inlet of the detection device for analyzing the sample in a fluid-conducting manner to form the detection loop,
the sample supply device comprising the sample inlet, that is connected to the sample supply stream inlet in a fluid-conducting manner by means of a first flow path for introducing the sample into the system, and the sample outlet, that is connected to the equalizing steam outlet in a fluid-conducting manner by means of the second flow path, and
the second conveyor for conveying the carrier stream containing the sample from the sample inlet to the sample outlet.

15. A method for supplying and analyzing a sample contained in a sample fluid stream using the system of claim 1, wherein the method comprises:
introducing the carrier stream laden with the sample via the sample inlet by the second conveyor for conveying the carrier stream from the sample inlet to the sample outlet;
introducing the sample supply stream into the mixing chamber via the sample supply stream inlet by means of the first flow path;
introducing the dilution stream into the mixing chamber via the dilution stream inlet through the detection loop driven by the first conveyor;
discharging the equalizing steam from the mixing chamber via the equalizing steam outlet by means of the second flow path;
discharging the sample fluid stream from the mixing chamber via the mixing chamber stream outlet through the detection loop driven by the first conveyor; and
removing the carrier stream via the sample outlet by the second conveyor for conveying the carrier stream from the sample inlet to the sample outlet.
